(19) United States
(12) Patent Application Publication
(10) Pub. No.: US 2007/0209755 A1
(43) Pub. Date: Sep. 13, 2007

(54) Apparatus for Printing and Applying an Adhesive Patch

(75) Inventor: Mark Smith, Leicestershire (GB)

Correspondence Address: FISH & RICHARDSON PC, P.O. BOX 1022, MINNEAPOLIS, MN, 55440-1022, US

(73) Assignee: MARKEM TECHNOLOGIES LIMITED, Nottingham (GB)

(21) Appl. No.: 11/672,643

(22) Filed: Feb. 8, 2007

(30) Foreign Application Priority Data
Feb. 15, 2006 (GB) 0603023.3

(51) Int. Cl. B32B 37/12; B32B 38/14; B65C 1/00; B65C 9/18

(52) U.S. Cl. 156/249; 156/387; 156/540; 156/541; 156/277; 156/DIG. 1; 156/DIG. 3; 156/DIG. 33

(57) ABSTRACT

An apparatus for printing and applying a patch which has a face with adhesive, to an article, the apparatus including a printing module and a patch applying module, the printing module including a transport mechanism for transporting the patch when removeably adhered to a backing, through a printing station where a print head is provided for effecting printing on the patch, and the printing module including a patch removing mechanism for removing the patch from the backing after printing and for feeding the patch through a printing module opening, to the patch applying module which is located at or adjacent to a face of the printing module, for applying to the article, and characterised in that the printing module has first and second faces each with an opening through which the printed patch may be led by the patch removing mechanism, and the patch applying module is locatable at at least either of the first face or the second face of the printing module depending upon the relative position of the article to which the patch is to be applied.

### BACKGROUND TO THE INVENTION

This invention relates to an apparatus for printing and applying a patch which has a face with adhesive, to an article. The patch may be a label on which information may be printed, or a radio frequency identification device (“RFID”), for examples only, and the article may be a package or an other item, for example which is being conveyed in a production or packaging facility.

### DESCRIPTION OF THE PRIOR ART

Such printing and applying apparatus are known which include a printing section where patches carried on a backing web are moved past a stationary or moving print head to effect printing. After printing, the patches are removed from their backing web, and applied by an applying section of the apparatus to an article. Alternatively the patches may be each be held stationary during printing while the print head moves relatively to the stationary patch.

The printing section may include a print head which applies rows of pixels of marking medium to the patch under computer control, to build up an image to be printed. The print head may for example be of the kind in which a ribbon carries the marking medium, pixels of which are removed by for example, energised heating elements of the print head, and transferred to the patch, or the print head may jet pixels of ink from nozzles onto the patch.

Further alternatively the printing section may include a laser which is actuated to fix ink to the patch

In each case the relative positions of the printing and applying sections of the apparatus are critical to proper operation of the apparatus. Moreover, an apparatus which has been designed for operation at one position relative to a conveyor conveying articles, for example at one side of the conveyor, cannot readily be used other than in similar relative positions, so that for example, conventional printing and applying apparatus cannot be used or at least cannot readily be used without major reconfiguration, on either side of a conveyor. Rather a printing and applying apparatus usually is constructed for dedicated use at one side of a conveyor i.e. the apparatus is handed.

### SUMMARY OF THE INVENTION

According to a first aspect of the invention we provide an apparatus for printing and applying a patch which has a face with adhesive, to an article, the apparatus including a printing module and a patch applying module, the printing module including a transport mechanism for transporting the patch when removeably adhered to a backing, through a printing station where a print head is provided for effecting printing on the patch, and the printing module including a patch removing mechanism for removing the patch from the backing after printing and for feeding the patch through a printing module opening, to the patch applying module which is located at or adjacent to a face of the printing module, for applying to the article, and characterised in that the printing module has first and second faces each with an opening through which the printed patch may be fed by the patch removing mechanism, and the patch applying module is locatable at at least either of the first face or the second face of the printing module depending upon the relative position of the article to which the printed patch is to be applied.

Thus a printing and applying apparatus is provided which is not handed or at least may be readily re-configured (re-handed) for use in different positions relative to a conveyor conveying articles onto which patches are to be applied.

In a preferred arrangement, a plurality of patches are carried on an elongate backing which is a web of material, by being releasably adhered to the backing web by the adhesive, the web and patches being stored on a supply spool from which the web and patches are transported through the printing station, the backing web from which patches have been removed by the patch removing mechanism passing to a backing web take-up spool for storage. The transport mechanism may transport the web and patches in a first direction through the printing station when the patch applying module is located at the first face of the printing module, and in a second direction opposite to the first direction when the patch applying module is located at the second face of the printing module.

The transport mechanism may include first and second backing web take-up spool drive members, which may be spindles alternatively or simultaneously drivable by a motor to drive a take-up spool to take-up the backing web. The backing web take-up spool may thus be locatable on and rotatable in a first direction of rotation, by the first backing web take-up spool drive member when the patch applying module is located at the first face of the printing module, and the backing web take-up spool being locatable on and rotatable in a second direction of rotation opposite to the first direction of rotation, by the second backing web take-up spool drive member, when the patch applying module is located at the second face of the printing module.

The supply spool may be mounted on a supply spool mounting member to deliver backing web and patches to the printing station, when patch applying module is located at the first or the second face of the printing module. However if desired, the direction in which the supply spool rotates to deliver the backing web and patches to the printing station may be reversed depending on the face of the printing module at or adjacent which the patch applying module is located.

Depending on the nature of the print head i.e. whether the print head is for example, of the kind having an array of heating elements to remove pixels of marking medium from a ribbon or another kind of print head for printing, the print head orientation at the print station, relative to the backing and label being transported through the printing station, may require adjustment for optimum printing performance depending upon the transport direction in which the backing and patch are being conveyed.

Preferably the print head is received at the print station by a mounting which permits the print head to be received in either one of two alternative orientations depending on the transport direction of the patches and backing through the printing station.

Whereas the patch applying module may be mounted separately from the printing module so as to be locatable at the first or second face of the printing module, preferably the patch applying module is mounted on the respective face. Thus each of the first and second faces of the printing module may have first mounting formations, which are co-operable with corresponding second mounting formations provided on the patch applying module, e.g. via fastenings.

Each of the printing module and the patch applying module need to be controlled in a co-ordinated way. Preferably the printing and applying apparatus is controlled by an electronic controller provided in or on either the printing or patch applying module. Electrical connections, including if desired an electrical power supply, may be established between the modules by a connector which includes a first connector part provided on each of the first and second faces of the printer module and a second connector part provided on the patch applying module, one of the first, and the second connector part engaging to provide the electrical connections, upon the patch applying module being mounted on the respective face of the printer module.

If desired, the patch applying module which is located at the first or second face of the printing module may be a primary patch applying module, and the printing and applying apparatus may include a secondary patch applying module located at or adjacent the primary patch applying module. The primary patch applying module may receive the printed patch from the printing module, and may be operable either to apply the printed patch to the article, or to allow the patch to be fed to the secondary patch applying module which is operable to apply the patch to the article. For example, the primary patch applying module may be operable to apply patches to the one sides of articles e.g. surfaces which extend transversely, e.g. generally perpendicularly to the respective first or second face of the printing module at which the primary patch applying apparatus is located, and the secondary patch applying module may be operative to apply patches to alternative surfaces of articles, e.g. surfaces of the articles which extend generally parallel to the respective first or second face of the printing module at which the primary patch applying apparatus is located.

Electrical connections between the primary and secondary patch applying modules, to enable the secondary patch applying module to be controlled by the controller, and if desired to receive electrical power, may be provided by a secondary connector which includes a first secondary connector part provided on the primary patch applying module and a second secondary connector part provided on the secondary patch applying module, the first and second secondary connector parts engaging to provide the electrical connections, upon the primary and secondary patch applying modules being mounted together.

The second connector part of the connector between the primary patch applying module and the printer module, and the first secondary connector part of the secondary connector between the primary and secondary patch applying modules, may each be engageable with either the first part of the connector of one of the first and second faces of the printing module, or the second secondary connector part of the secondary patch applying module, so that the positions of the primary and secondary patch applying modules are interchangeable.

According to a second aspect of the invention we provide a method of re-handing a printing and applying apparatus of the first aspect of the invention which is provided for operation at one position relative to a conveyor conveying articles with the patch applying module located at a first face of the printing module, for operation at an alternative position relative to the conveyor, the method including re-locating the patch applying module to the second face of the printing module.

### BRIEF DESCRIPTION OF THE DRAWINGS

Embodiments of the invention will now be described with reference to the accompanying drawings in which:

FIGS. 1a and 1b are illustrative plan views of a patch printing and applying apparatus in accordance with the inventions, FIG. 1a showing the apparatus in one condition and FIG. 1b in an alternative condition;

FIGS. 2a and 2b show details of a print head and its mounting at a printing station, respectively for an apparatus in its FIG. 1a and FIG. 1b positions;

FIG. 3 is an illustrative plan view of an alternative patch printing and applying apparatus in accordance with the present invention, having primary and secondary patch applying modules.

### DESCRIPTION OF THE PREFERRED EMBODIMENTS

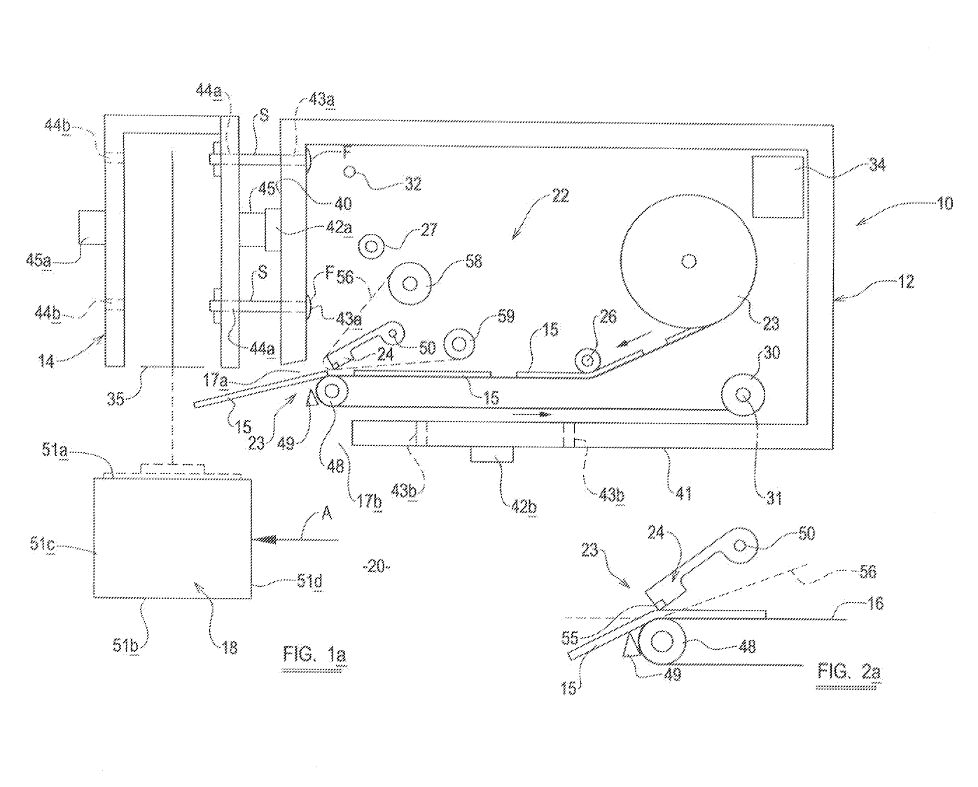

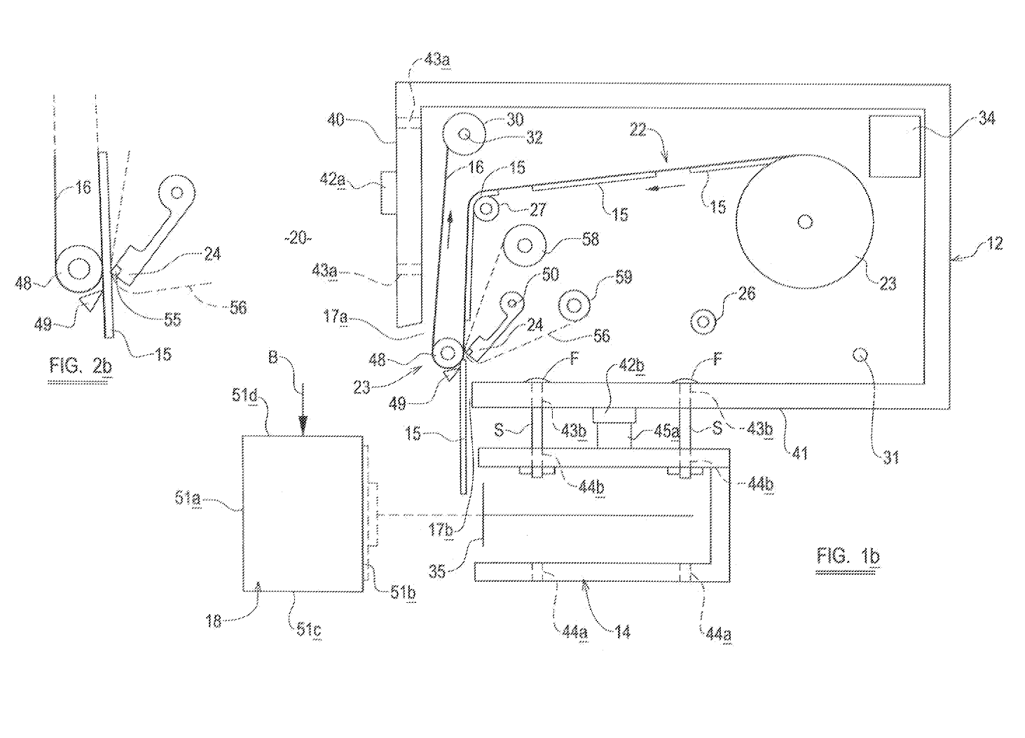

Referring to FIGS. 1a, 1b, 2a and 2b of the drawings, a patch printing and applying apparatus 10 is shown, which includes a printing module 12 and a patch applying module 14, the printing module 12 in use, printing information on each of a plurality of patches 15 which are provided on an elongate backing web 16, and the patch applying module 14, receiving the patches 15 from the printing module 12, and applying them each to an article 18, which in the present example, is a package which is conveyed past the apparatus 10 on a conveyor 20.

The printing module 12 includes a transport mechanism 22 for transporting the patches 15 on the web backing 16, severally through a printing station 23 where a print head 24 is provided for effecting printing on the patches 15. The transport mechanism 22 includes two guide rollers 26, 27 in this example, one 26 of which is shown in use in FIG. 1a, whilst the other 27 is shown in use in FIG. 1b, such that only one of the guide rollers 26, 27 is in use depending upon the configuration of the printing module 12 as hereinafter explained. The transport mechanism 22 further includes a backing web 16 take-up spool 30 which is mounted on and driven by one or other of a pair of drive members which in this example are spindles 31, 32, again depending on the configuration, and a backing web 16 supply spool 23 which provides a store of patches to be printed upon and to be transported by the transport mechanism 22 through the printing station 23.

The printing module 12 further includes a controller 34 which may be connected via appropriate connections (not shown) to an upstream data source, and to a system controller which may co-ordinate the operation of the printing and applying apparatus 10 with other production/packaging line equipment.

The patches 15 in this example are simple lamina labels, which have a face on which information is printed by the print head 24, and an opposite face with adhesive by means of which the labels 15 may be attached to the articles 18 when applied. The backing web 16 provides a surface to which the labels 15 are removably adhered, the surface readily releasing the adhesive when the labels 15 are peeled from the backing web 16.

In another example, the patches 15 may be RFID tags, which again have an adhesive coated face by means of which the tags 15 may be attached to the articles 18 to which they are applied. The transport mechanism 22 may be configured to transport the tags, which may have a thickness greater than a simple label, and the printing station 23 may be configured to permit of printing on the RFID tags, for example around any functional parts of the tags 15. Other kinds of patches upon which it is desired to print information and then to apply the patches 15 to articles 18 may be transported by the transport mechanism 22 and printed upon at the printing station 23 as required.

Moreover the patches 15 need not be carried on an elongate backing web 16 as described, but may be transported on another backing, through the printing station. For example, the patches 15 may be provided as a stack of patches 15, the patches 15 being transported severally from the stack and to the printing station 23 where the patches 15 are printed upon.

The patch applying module 14 may be of any desired kind. In the example diagrammatically illustrated, the module 14 includes an applicator surface 35 which is moved by an actuator (not shown) from a first position shown in full lines in FIGS. 1a and 1b, depending upon the position of the apparatus 10, where the applicator surface 35 may receive a printed label from the printing module 12, to a second position shown in dotted lines in FIGS. 1a and 1b, where a patch 15 on the applicator surface 35 may be applied to an article 18.

However for another kind of patch applying module 14, the patches 15 may be applied not by moving the applicator surface 35, but by propelling the patches 15 e.g. using blast of air, onto the articles 18.

In each case, the patches 15 are held by the applicator surface 35, e.g. by suction or by stickiness of the surface 35, with the printed faces of the patches 15 adjacent the applicator surface 35 so that when the patches 15 are applied to the articles 18, the faces with the adhesive are applied to the articles 18 so that the patches 16 become attached to the articles 18.

Referring now particularly to FIG. 1a, the patch printing and applying apparatus 10 is provided in a first position, at the right hand side of the conveyor 20 as seen in the drawing. The patch printing and applying apparatus 10 is in a first configuration in which the patches 15 are printed and applied to articles 18 being conveyed in the direction indicated by arrow A. As shown in the example, the apparatus 10 is right handed i.e. is positioned to the right of the conveyor 20 as seen.

In this configuration, the patch applying module 14 is located at a first face 40 of the printing module 12 where there is provided a first connector part 42 of an electrical connector. The first face 40 has openings 43a which provide first mounting formations whilst the patch apply module 14 provides openings 44a, which are aligned with the first mounting formations 43a and provide second mounting formations which may co-operate with the first mounting formations 43a by fasteners F and spacers S, to mount the patch applying module 14 at the first face 40 of the printing module 12. The patch applying module 14 further has a second connector part 45 which engages with the first connector part 42a to establish electrical connections and if desired to provide a power supply to the patch applying module 14, between the printing module 12 which has the apparatus controller 34, and the patch applying module 14. Thus the patch applying module 14 may be controlled by the controller 34 in a co-ordinated way with the printing module 12.

When the print and applying apparatus 10 is in this first position, it will be appreciated that for the applicator surface 35 of the patch applying module 14 to receive a patch 15 from the printing module 12, the patch 15 needs to be fed from the printing module 12 in a direction generally parallel to the direction A in which the articles 18 are conveyed i.e. generally parallel to the applicator surface 35, through an opening 17a in the printing module 12 first face 40.

At the printing station 23 there is provided a patch removing mechanism provided by a backing roller 48 to the print head 24, and a beak 49. As a patch 15 is printed upon by the print head 24, and advanced, the elongate backing web 16 is made to turn around the backing roller 48 and beak 49, on its way to the take-up spool 30 which is provided on a first 31 of the drive spindles, and thus the patch 15, which is less flexible than the backing web 16, is peeled from the backing web 16. As is well known in the art, the beak 49 is provided immediately downstream of the backing roller 48 to encourage and ensure removal of the patches 15 from the backing web 16.

With the apparatus 10 in its first condition shown in FIG. 1a, the backing web 16 and patches 15 are pulled from the supply spool 23 which is arranged to rotate in a clockwise direction. The backing web 16 and patches 15 pass around a guide roller 26 and hence to the printing station 23.

As can be more clearly seen in FIGS. 2a and 2b, the print head 24 is received at the print station 23 on a mounting 50 which permits the print head 24 to be received in either one of two alternative orientations, depending on the transport direction of the patches 15 and backing web 16 through the printing station 23. In FIGS. 1a and 2a, the print head 24 is generally above the backing roller 48.

Thus after printing, the patches 15 are fed from the printing module 12 as indicated in FIG. 1a, in a first direction generally parallel to direction A towards the applicator surface 35. The printed patch 15 may dwell in the position shown with the backing web 16 transport halted by the transport mechanism 22 of the printing module 12, or may be fed onto the applicator surface 35 to dwell there, until a package 18 arrives on the conveyor 20, to which the patch 15 is to be applied. In the present example, the patch applying module 14 is arranged to apply the patches 15 to side surfaces 51a of the articles 18, which face the apparatus 10 as they are conveyed past, but in another example the patch applying module 14 may apply the patches to front 51c or rear 51d surfaces of the oncoming articles 18, depending on the nature of the patch applying module 14.

It can be seen in FIG. 1a that the printing module 14 has a second face 41 generally perpendicular to the first face 40 at which the patch applying module is located. The second face 41 includes a first electrical connector part 42a identical to the first connector part 42a on the first face 40, for a purpose explained below. Also the second face 41 has unoccupied openings 43b (first mounting formations) for fasteners for a reason explained below.

In this example, the print head 24 is of the thermal kind having a linear array 55 of heating elements which may be individually energised by the controller 34, to remove pixels of marking medium i.e. ink, from a ribbon 56 which passes between the print head 24 and the patches 15 to be printed upon, to effect printing.

In the example shown, the ribbon 56 is provided on a supply spool 58, and passes to the printing station 23, and then ribbon 56 from which pixels of ink have been removed, is taken upon on a used ribbon take-up spool 59. The take-up spool 59, alone or with the supply spool 58, may be driven to effect ribbon transport, or another ribbon drive mechanism may be provided as required. Generally the ribbon 56 will be moved simultaneously with the patches 15 during printing, but may be driven at a differential speed to the patches 15 to effect ribbon saving, in the same or opposite directions to patch 15 movement.

When in the condition of FIG. 1a, the guide roller 27 of the ribbon transport mechanism 22 is redundant, as is the take-up spool drive spindle 32, as is the first part 42a of the electrical connector on the second face 41 of the printing module 12, and the first mounting formations 43b of the second face 41 of the printing module 12.

If it is desired to position the patch printing and applying apparatus 10 to the left of the conveyor 20, for example, so that patches 15 may be applied to surfaces 51b of the articles 18 opposite to the first side surfaces 51a to which the patches 15 may be applied as seen in FIG. 1a, the apparatus 10 may be re-located to the left side of the conveyor 20 and simply and quickly reconfigured as follows.

The patch applying module 14 needs to be separated from the printing module 12 by removing the fasteners F and spacers S, and separating the first 42a and second 45 parts of the electrical connector.

The patch applying module 14 may then be located at the second face 41 of the printing module 12, and mounted by the fasteners F and spacers S, using the first mounting formations 45b of the second face 41 and second mounting formations 44b provided by the patch applying module 14. The first connector part 42b provided at the second face 41 of the printing module 12 is engaged with a second connector part 45a provided on an opposite side of the patch applying module 14 to the second connector part 45 which is engaged with the first connector part 42 at the first face 40 of the printer module 12. Thus in the condition of FIG. 1b, the first connector part 42a and openings 43a in the first face 40 of the printing module 12 will be redundant.

The apparatus 10 may then be positioned at the left side of the conveyor 20 as shown, with the first face 40 of the printing module 12 adjacent the conveyor 20.

To ensure that patches 15 are fed from the printing module 12 onto the applicator surface 35 of the patch applying module, the transport mechanism 22 is reconfigured too, and the print head 24 is re-oriented. In this configuration the patches 15 are fed from the printing module 12 through an opening 17b in the second face 41.

As seen in FIG. 1b, the backing web 15 and patches 15 are re-routed so as to be transported by the transport mechanism 22 in generally, in an opposite direction to that in FIG. 1a, the backing web 16 and patches 15 being pulled from the supply spool 23 as the supply spool 23 rotates in an anti-clockwise direction.

The backing web 16 and patches 15 then pass around the guide roller 27 which was redundant in the FIG. 1a condition, and hence to the printing station 23.

As can be seen in FIG. 2b, the print head 24 is re-orientated on its mounting 50 so as to be located generally at a side, rather than above as seen in the drawings, the backing roller 48, and the beak 49, which typically is carried with the print head 14, assumes an alternative position to that shown in FIG. 2a.

After a patch 15 is printed upon at the printing station 23, the patch 15 is removed from the backing web 16 and fed from the printing module 12 in a direction generally perpendicular to that in FIG. 2a with respect to the printing module 12, to the applicator surface 35, for applying to the side surface 51b of an oncoming package 18 or other article.

In the condition shown in FIG. 1b, the guide roller 26 around which the backing web 16 and patches 15 were entrained in FIG. 1a, is redundant, as is the drive spindle 31 on which the take-up spool 30 was mounted in the FIG. 1a condition. printing module 12 to another configuration in which the patch applying module 14 is located at or adjacent a second face 41 of the printing module 12.

Alternative mounting formations by means of which the patch applying module 14 may be mounted alternatively to the first 40 or the second face 41 of the printing module 12 may be provided.

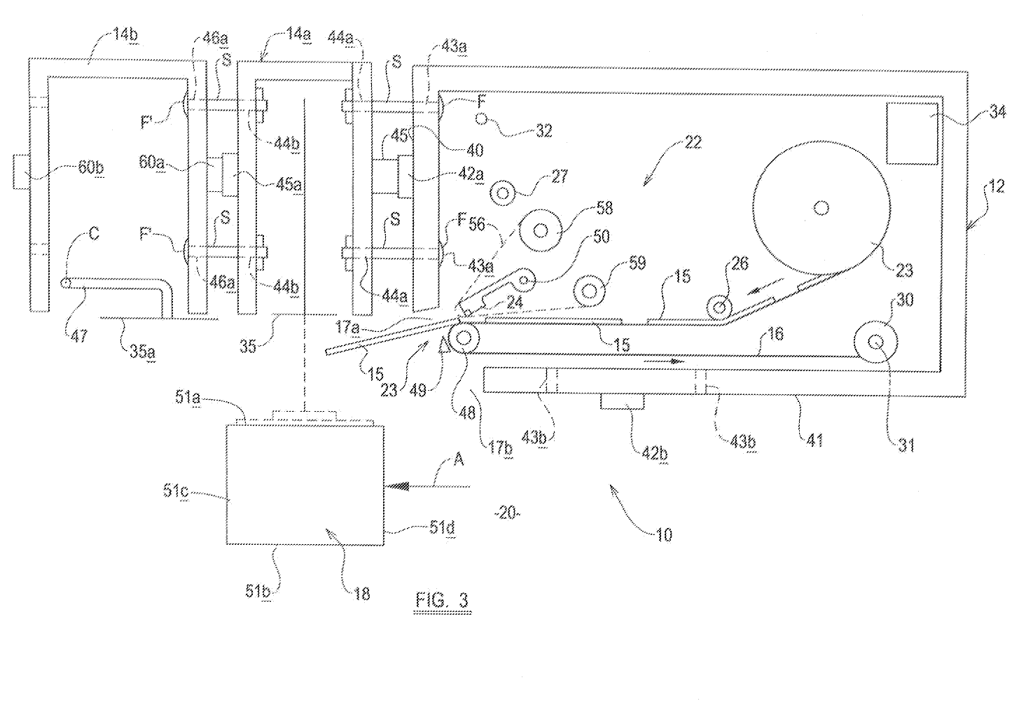

Referring now to FIG. 3 an alternative embodiment of the invention is diagrammatically illustrated. Similar parts to the apparatus of FIGS. 1a, 1b, 2a and 2b are indicated by the same references.

In this embodiment, which shows the apparatus 10 in a right handed configuration to the right of the conveyor 20, as with the apparatus 10 in FIG. 1a, there is provided a primary patch applying module 14a which is located at the first face 40 of the printing module 12 which is substantially identical to the patch applying module 14 of the FIGS. 1a and 1b embodiment i.e. the primary patch applying module 14a is operational to applying patches 15 to side surfaces 51a of articles 18 conveyed past the apparatus 10 in the direction of arrow A, and additionally a secondary patch applying module 14b, is provided.

The secondary patch applying module 14b is provided on or adjacent the primary patch applying module 14a, remote from the printing module 12, and the primary patch applying module 14a may receive the printed patch 15 from the printing module 12, and may be operable either to apply the printed patch 15 to the side surface 51a of an article 18 from the applicator surface 35, or the primary patch applying module 14a may allow the patch 15 to be fed to the secondary patch applying module 14b.

The patch applying module 14 may still be controlled by the controller 34 of the printing module 12 by virtue of the electrical connector.

It will be appreciated that re-configuration of the apparatus 10 for right or left handed operation may simply be achieved because the printing module 12 and the patch applying module 14 both have mounting formations 43a, 43b and 44a, 44b and electrical connector parts 42a, 45 and 42b, 45a which may be used in either right or left handed conditions. An operator only needs mechanically to relocate the patch applying module 14 to the respective first or second face 40, 41 of the printing module 12, re-orientate the print head 24 on its mounting 50 and re-thread the backing web 16 as described, to enable the apparatus 10 to be used in a right handed or left handed position. Desirably the inked ribbon 56 is drivable in either direction such that no reconfiguration of the ribbon 56 drive is needed.

Various modifications are possible without departing from the scope of the invention.

For example the print head 24 need not be of the thermal kind but may for example only, may be another pixel based print head such as an ink-jet heat, or may be a laser print head. In these cases, a supply of inked ribbon 56 would not be required.

The transport mechanism 22 described is only exemplary. Many alternative configurations are possible in which the direction in which the patches 15 are fed to and from the printing station 23 may be varied for one configuration in which the patch applying module 14 is located at or adjacent a first face 40 of the

In this latter case, the secondary patch applying module 14b may be operated to apply the patch 15 to the article 18, and in the example shown, the secondary patch applying module 14b may be operative to apply patches 15 to the rear 51d surfaces of the articles 18 which extend generally parallel to the respective first face 40 of the printing module 12 at which the primary patch applying apparatus 14a is located in this example.

The secondary patch applying module 14b may include an applicator surface 35a carried on a pivoted arm 47 which is pivoted about a pivot axis C, once the articles 18 have passed the secondary patch applying module 14b, to apply the patches 15 to the rear surfaces 51d of the articles 18. The applicator surface 35a carries a printed patch 15 received thereby to the rear surface 51d of an article 18 to apply the patch 15, but in another example, the secondary patch applying module 14b may have an applicator surface which positions a printed patch 15 in the path of an oncoming article 18 thus to apply the patch 15 to a forward facing, front surface 51c of the article 18.

Electrical connections between the primary 14a and secondary patch 14b applying modules, to enable the secondary patch applying module 14b to be controlled by the controller 34 of the printing module 12, and if desired to receive electrical power, are provided by first part 45a of a secondary connector of the primary patch applying module 14a which otherwise (in the FIG. 1a arrangement) would be redundant, which first secondary connector part 45a engages with a second secondary connector part 60a of the secondary patch applying module 14b, as the secondary patch applying module 14b is mounted to the primary patch applying module 14a. Such mounting is achieved by fasteners F and spacers S, using otherwise redundant openings 44b of the primary printing module 14a which are opposite to the openings 44a used to mount the primary patch applying module 14a to the first face 40 of the printing module 12, and corresponding co-operable openings 46a in the secondary patch applying module 14b.

It will be appreciated that where required, the patch applying module 14b which applies the patches 15 to the rear 51d or front 51c surfaces of the articles 18 may be located at the first or second face 40, 41 of the printing module 12, and may thus be the primary patch applying module, and the patch applying module 14a which applies patches 15 to one or other of the side surfaces 51a, 51b of the articles 18 may be located at or adjacent the patch applying module 14b which is located at the first or second face 40, 41 of the printing module 12.

Otherwise, the apparatus 10 shown in FIG. 3 may be re-configured for opposite handed operation at an alternative position e.g. to the left of the conveyor 20, as desired, in the same way as described above with reference to FIG. 1b.

In another arrangement, the print head 14 need not be re-orientated when re-configuring/re-positioning the apparatus 10.

In another embodiment, the patch applying module 14, 14a need not be mounted to the printing module 12 as described, but may otherwise be located relative to the printing module 12.

In another embodiment, the openings 17a, 17b through which the patches 15 are fed from the printing module 12 and which in the diagrams indicates that such openings are provided by a continuous opening at a corner of the printing apparatus 12, may be provided by discrete openings 17a, 17b in the respective first and second faces 40, 41 of the printing module 12.

In another embodiment, the apparatus controller 34 may be provided in the patch applying module 14 rather than the printing module 12, to control the printer module 12 from the patch applying module 14.

1. An apparatus for printing and applying a patch which has a face with adhesive, to an article, the apparatus including a printing module and a patch applying module, the printing module including a transport mechanism for transporting the patch when removeably adhered to a backing, through a printing station where a print head is provided for effecting printing on the patch, and the printing module including a patch removing mechanism for removing the patch from the backing after printing and for feeding the patch through a printing module opening, to the patch applying module which is located at or adjacent to a face of the printing module, for applying to the article, and wherein the printing module has first and second faces each with an opening through which the printed patch may be fed by the patch removing mechanism, and the patch applying module is locatable at at least either of the first face or the second face of the printing module depending upon the relative position of the article to which the printed patch is to be applied.

2. An apparatus according to claim 1 wherein a plurality of patches are carried on an elongate backing which is a web of material, by being releasably adhered to the backing web by the adhesive, the web and patches being stored on a supply spool from which the web and patches are transported through the printing station, the backing web from which patches have been removed by the patch removing mechanism passing to a backing web take-up spool for storage.

3. An apparatus according to claim 2 wherein the transport mechanism transports the web and patches in a first direction through the printing station when the patch applying module is located at the first face of the printing module, and in a second direction opposite to the first direction when the patch applying module is located at the second face of the printing module.

4. An apparatus according to claim 2 wherein the transport mechanism includes first and second backing web take-up spool drive members, drivable by a motor to drive a take-up spool to take-up the backing web, the backing web take-up spool being locatable on and rotatable in a first direction of rotation, by the first backing web take-up spool drive member when the patch applying module is located at the first face of the printing module, and the backing web take-up spool being locatable on and rotatable in a second direction of rotation opposite to the first direction of rotation, by the second backing web take-up spool drive member, when the patch applying module is located at the second face of the printing module.

5. An apparatus according to claim 2 wherein the supply spool is mounted on a supply spool mounting member to deliver backing web and patches to the printing station, when patch applying module is located at the first or the second face of the printing module.

6. An apparatus according to claim 5 wherein the direction in which the supply spool rotates to deliver the backing web and patches to the printing station is reversed depending on the face of the printing module at or adjacent which the patch applying module is located.

7. An apparatus according to claim 1 wherein the print head orientation at the printing station, relative to the backing and label being transported through the printing station is adjustable depending upon the transport direction in which the backing and patch are being conveyed.

8. An apparatus according to claim 7 wherein the print head is received at the printing station by a mounting which permits the print head to be received in either one of two alternative orientations depending on the transport direction of the patches and backing through the printing station.

9. An apparatus according to claim 1 in which the print head is a thermal print head having an array of heating elements to remove pixels of marking medium from a ribbon to effect printing.

10. An apparatus according to any one of the preceding claims wherein the patch applying module is mounted on the respective face, each of the first and second faces of the printing module having first mounting formations, which are co-operable with corresponding second mounting formations provided on the patch applying module.

11. An apparatus according to claim 1 wherein the apparatus is controlled by an electronic controller provided in or on either the printing or patch applying module.

12. An apparatus according to claim 11 where the patch applying module is mounted on the respective face, each of the first and second faces of the printing module having first mounting formations, which are co-operable with corresponding second mounting formations provided on the patch applying module, wherein electrical connections are established between the modules by a connector which includes a first connector part provided on each of the first and second faces of the printer module and a second connector part provided on the patch applying module, one of the first, and the second connector part engaging to provide the electrical connections, upon the patch applying module being mounted on the respective face of the printer module.

13. An apparatus according to claim 1 wherein the patch applying module which is located at the first or second face of the printing module is a primary patch applying module, and the printing and applying apparatus includes a secondary patch applying module located at or adjacent the primary patch applying module.

14. An apparatus according to claim 13 wherein the primary patch applying module receives the printed patch from the printing module, and is operable either to apply the printed patch to the article, or to allow the patch to be fed to the secondary patch applying module which is operable to apply the patch to the article.

15. An apparatus according to claim 13 wherein the primary patch applying module is operable to apply patches to the one sides of articles and the secondary patch applying module is operative to apply patches to alternative sides of articles.

16. An apparatus according to claim 15 wherein the primary patch applying module is operable to apply patches to surfaces of the articles which extend transversely to the respective first or second face of the printing module at which the primary patch applying apparatus is located and the secondary patch applying module is operable to apply patches to alternative surfaces of the articles which extend generally parallel to the respective first or second face of the printing module at which the primary patch applying apparatus is located.

17. An apparatus according to claim 13 wherein electrical connections between the primary and secondary patch applying modules are provided by a secondary connector which includes a first secondary connector part provided on the primary patch applying module and a second secondary connector part provided on the secondary patch applying module, the first and second secondary connector parts engaging to provide the electrical connections, upon the primary and secondary patch applying modules being mounted together.

18. An apparatus according to claim 17 wherein the second connector part of the connector between the primary patch applying module and the printer module, and the first secondary connector part of the secondary connector between the primary and secondary patch applying modules, are each engageable with either the first part of the connector of one of the first and second faces of the printing module, or the second secondary connector part of the secondary patch applying module.

19. A method of re-handing a printing and applying apparatus a printing module and a patch applying module, the printing module including a transport mechanism for transporting the patch when removeably adhered to a backing, through a printing station where a print head is provided for effecting printing on the patch, and the printing module including a patch removing mechanism for removing the patch from the backing after printing and for feeding the patch through a printing module opening, to the patch applying module which is located at or adjacent to a face of the printing module, for applying to the article, and wherein the printing module has first and second faces each with an opening through which the printed patch may be fed by the patch removing mechanism, and the patch applying module is locatable at at least either of the first face or the second face of the printing module depending upon the relative position of the article to which the printed patch is to be applied wherein the apparatus is provided for operation at one position relative to a conveyor conveying articles with the patch applying module located at a first face of the printing module, the rehanding method rehanding the apparatus for operation at an alternative position relative to the conveyor, the method including re-locating the patch applying module to the second face of the printing module.
